(19) United States
(12) Patent Application Publication
(10) Pub. No.: US 2011/0167020 A1
(43) Pub. Date: Jul. 7, 2011

(54) Hybrid Simulation Methodologies To Simulate Risk Factors

(76) Inventors: Zhiping Yang, Cary, NC (US); Donald James Erdman, Raleigh, NC (US); Stacey Michelle Christian, Cary, NC (US); Wei Chen, Apex, NC (US)

(21) Appl. No.: 12/683,020

(22) Filed: Jan. 6, 2010

(51) Int. Cl. G06Q 40/00

(52) U.S. Cl. 705/36 R; 705/38

(57) ABSTRACT

Computer-implemented systems and methods are provided for generating a simulated forecast based on members of a pool of input risk factor variables. Certain members of the pool of input risk factor variables are identified as members of a first set of variables, and certain other members of the pool of input risk factor variables are identified as members of a second set of variables. A first simulation is generated via a first simulation method using the first set of variables, and a second simulation is generated via a second simulation method that differs from the first simulation method using the second set of variables. The first simulation and the second simulation are generated using correlations among variables in the first set of variables and variables in the second set of variables.

### FIELD

The technology described herein relates generally to risk factor simulation and more specifically to the application of different simulation techniques to different risk factors in a single simulation.

### BACKGROUND

In order to forecast risk, a set of variables that describe the economic state of the world are simulated into the future. These variables are often called risk factors. The risk factors have different attributes and behaviors and are unique contributors to the entire economic system. The risk factors are often modeled as a correlated system. A simulation forecast of interest is usually not only a single point but a distribution of possible values in the future. Using the simulated forecasted values of the risk factors, a portfolio may be analyzed to calculate a risk measure, such as Value at Risk (VaR).

There are several popular simulation methods including: Monte Carlo simulation, covariance matrix simulation, historical simulation, scenario simulation, as well as others. All of these simulation methods have their own advantages and limitations. From a technical point view, each simulation methodology has one or more, but not all, of these advantages: an accurate forecast; easy specification; and fast simulation computation. Unfortunately each also suffers from one or more of the following drawbacks: inaccuracy of forecasts, difficult specification, and slow simulation computation. Traditionally, because of the importance of the correlation between risk factors, only a single simulation method was used for all risk factors in a risk management application.

### SUMMARY

In accordance with the teachings herein, computer-implemented systems and methods are provided for generating a simulated forecast based on members of a pool of input risk factor variables. Certain members of the pool of input risk factor variables are identified as members of a first set of variables, and certain other members of the pool of input risk factor variables are identified as members of a second set of variables. A first simulation is generated via a first simulation method using the first set of variables, and a second simulation is generated via a second simulation method that differs from the first simulation method using the second set of variables. The first simulation and the second simulation are generated using correlations among variables in the first set of variables and variables in the second set of variables.

As another example, a computer-implemented method for providing a simulated forecast based on correlated members of a pool of input risk factor variables representing input data includes identifying certain members of the pool of input risk factor variables as being members of a first set of variables and identifying certain other members of the pool of input risk factor variables as being members of a second set of variables. A first simulation is generated via a first simulation method using the first set of variables to generate a set of first results, and a second simulation is generated via a second simulation method that differs from the first simulation method using the second set of variables to generate a set of second results. The first simulation and the second simulation are generated utilizing correlations among variables in the first set of variables and variables in the second set of variables, and the set of first results and the set of second results are stored as a simulated forecast in a computer-readable memory.

As an additional example, a computer-implemented system for providing a simulated forecast based on correlated members of a pool of input risk factor variables representing input data includes a data processor. The system further includes a computer-readable memory encoded with instructions for commanding the data processor to perform a method that includes identifying certain members of the pool of input risk factor variables as being members of a first set of variables and identifying certain other members of the pool of input risk factor variables as being members of a second set of variables. A first simulation is generated via a first simulation method using the first set of variables to generate a set of first results, and a second simulation is generated via a second simulation method that differs from the first simulation method using the second set of variables to generate a set of second results. The first simulation and the second simulation are generated utilizing correlations among variables in the first set of variables and variables in the second set of variables, and the set of first results and the set of second results are stored as a simulated forecast in the computer-readable memory.

As a further example, a computer-readable memory may be encoded with instructions for commanding a data processor to perform a method that includes identifying certain members of the pool of input risk factor variables as being members of a first set of variables and identifying certain other members of the pool of input risk factor variables as being members of a second set of variables. A first simulation is generated via a first simulation method using the first set of variables to generate a set of first results, and a second simulation is generated via a second simulation method that differs from the first simulation method using the second set of variables to generate a set of second results. The first simulation and the second simulation are generated utilizing correlations among variables in the first set of variables and variables in the second set of variables, and the set of first results and the set of second results are stored as a simulated forecast in a computer-readable memory.

### BRIEF DESCRIPTION OF THE DRAWINGS

FIG. 1 depicts a computer-implemented environment wherein users can interact with a hybrid simulation engine hosted on one or more servers through a network.

FIG. 2 is a block diagram depicting example inputs and outputs of a hybrid simulation engine.

FIG. 3 is a flow diagram depicting a hybrid simulation process.

FIG. 4 is a flow diagram depicting an automated identification of risk factor subgroups.

FIG. 5 is a flow diagram depicting a hybrid simulation process where the variable set identification is a manual process dictated by user input.

FIG. 6 is a flow diagram depicting a hybrid simulation engine that maintains correlations among risk factors in different subgroups using a copula.

FIG. 7 is a flow diagram depicting a generation of a simulated forecast using a hybrid simulation engine that utilizes a copula to maintain correlations among variables.

FIGS. 8A, 8B, and 8C depict example processing systems for use in implementing a hybrid simulation engine.

### DETAILED DESCRIPTION

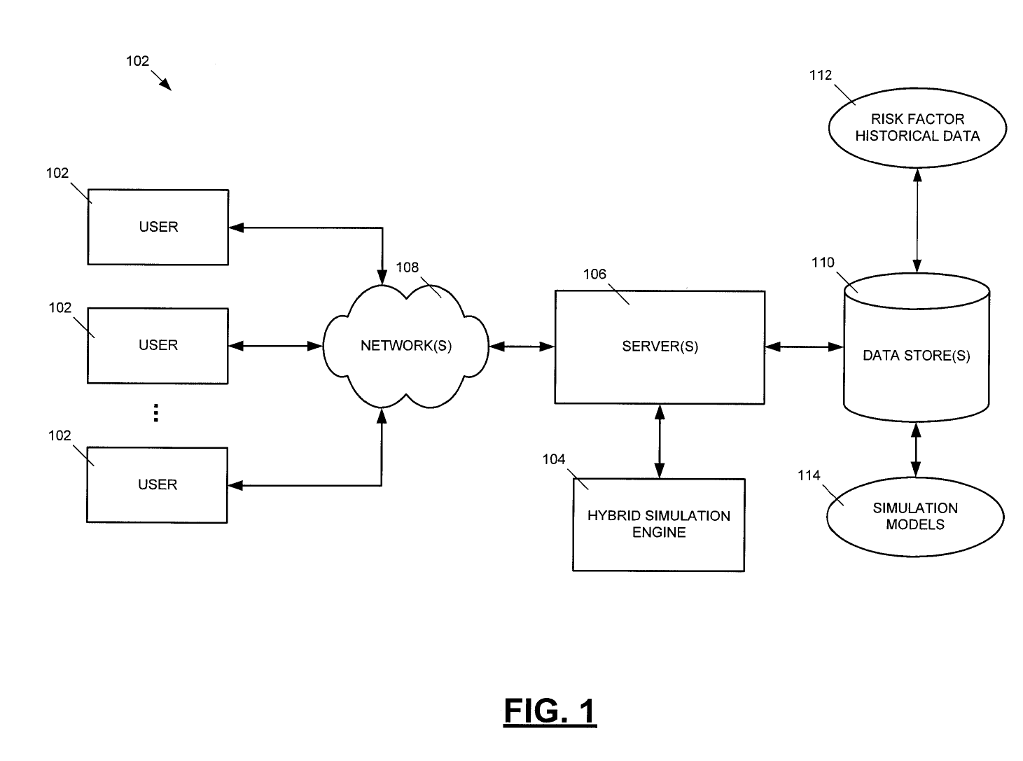

FIG. 1 depicts a computer-implemented environment wherein users 102 can interact with a hybrid simulation engine 104 hosted on one or more servers 106 through a network 108. The hybrid simulation engine 104 enables specification of the most appropriate simulation methods to be applied to subgroups of risk factors within the overall risk system. For example, users can determine which subset of risk factors for which the user may want to emphasize an accurate forecast, while for other risk factors the user may wish focus on fast simulation computation based on the nature of the risk factors or the availability of historical data. This flexibility enables a user to determine the optimal tradeoff between accuracy and performance when simulating a complicated system. The hybrid simulation engine 104 may retain original correlation structures in order to maintain correlations among risk factors simulated using different simulation methods during operation of those different simulation methods. For example, algorithms specified by the marginal distribution and copula theorems may be used to maintain the correlation structure of risk factors simulated by the different simulation methods.

A hybrid simulation generator 104 may be utilized in a variety of ways. For example, users want to model multiple groups of risk factors that describe different sources of risk in one integrated system. Different risk factor groups may be best modeled by specific simulation methods. The hybrid simulation engine 104 provides one, easy mechanism to capture all the risk sources at the same time. As another example, it may be desirable to put time and effort into modeling risk factors that have a significant impact on a target forecast variable and to use simpler methods to model the remaining factors. This hybrid simulation engine provides flexibility for using more computational time on the risk factors that are deemed important and less time on the remaining risk factors. As a further example, it may be desirable to retain the correlation structure of a risk system which either is specified by the user 102 or extracted a time-series dataset. The hybrid simulation engine 104 provides the capability for using different simulation methods to subgroups of risk factor while retaining the original correlation structure among variables in those different simulations during the simulations.

A hybrid simulation engine 104 may increase capability and flexibility of simulations, simulate systems with various characteristics of risk factors, generated an integrated simulation result, improve performance without significant loss of accuracy, provide easy specification of large systems of risk factors, retain the original correlation relationships of all risk factors, as well as many other features as described herein. The system 104 contains software operations or routines for providing a simulated forecast based on correlated members of a pool of input risk factor variables representing input data, such as historical time-series data. The generated data model can be used for many different purposes, such as simulation of physical processes (e.g., manufacturing processes, financial transaction processes, etc.) over a period of time. The users 102 can interact with the system 104 through a number of ways, such as over one or more networks 108. One or more servers 106 accessible through the network(s) 108 can host the hybrid simulation engine 104. The hybrid simulation engine 104 provides a simulated forecast based on correlated members of a pool of input risk factor variables representing input data. The one or more servers 106 are responsive to one or more data stores 110 for providing input data to the hybrid simulation engine 104. Among the data contained on the one or more data stores 110 may be risk factor historical data 112 used in configuring data models for simulations as well as simulation models themselves 114. It should be understood that the hybrid simulation engine 104 could also be provided on a stand-alone computer for access by a user 102.

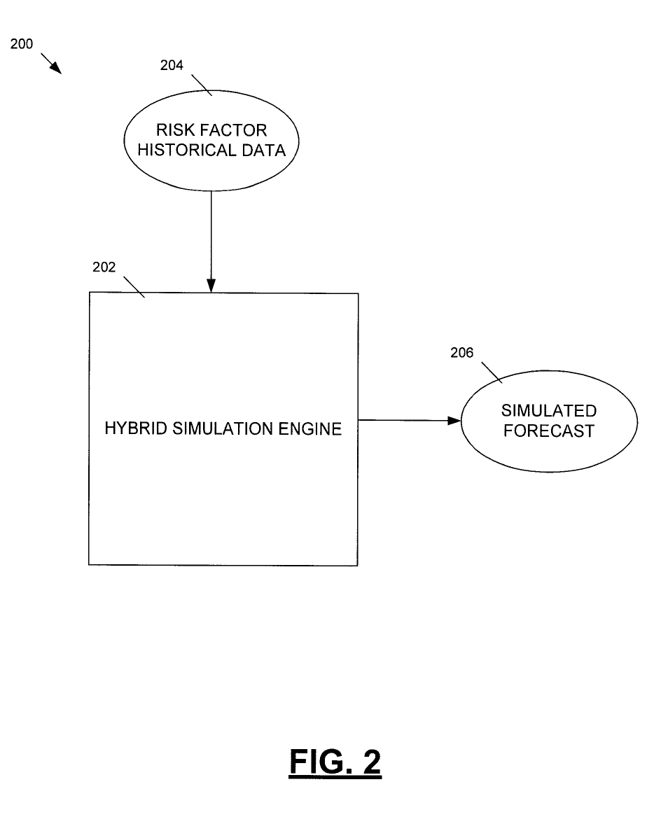

FIG. 2 is a block diagram depicting example inputs and outputs of a hybrid simulation engine. A hybrid simulation engine 202 receives risk factor historical data 204 as an input. For example, the hybrid simulation engine 202 may receive historical time-series data for each of the plurality of risk factor variables to be simulated. The plurality of risk factors are grouped into a plurality of subgroups, and the risk factors may then be simulated using different simulation techniques to generated a simulated forecast 206 for all or a portion of the risk factor variables for which historical data 204 is received. A simulated forecast 206 for a risk factor variable may be a single value, a forecast of a most-likely value, a set of simulated values, a distribution of simulated values, or some other representation of future values of a risk factor variable identified by the hybrid simulation engine 202. The simulated forecast values 206 for the risk factor variables may be useful as output in themselves, or they may be utilized in projecting values of other variables based on the simulated forecast values. For example, a projected stock price may be calculated based on simulated forecast values for related risk factors such as interest rates, exchange rates, as well as other risk factor variables.

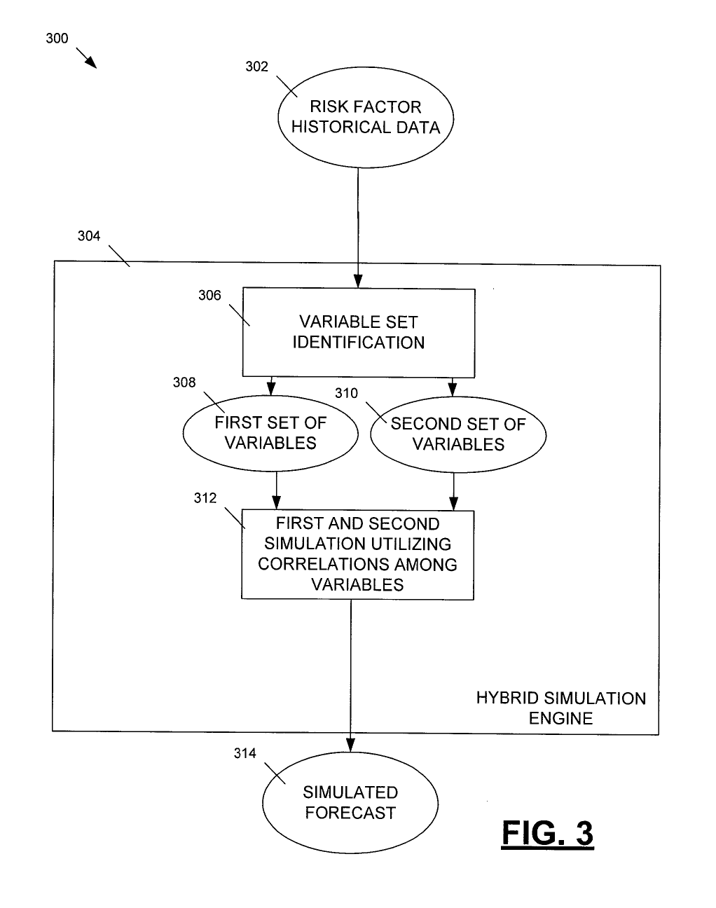

FIG. 3 is a flow diagram depicting a hybrid simulation process. Risk factor historical data 302, such as time-series data representative of past data for each risk factor, is received by the hybrid simulation engine. A variable set identification 306 divides the risk factors into two or more subgroups for further processing. The dividing of the risk factors into subgroups may be a manual process via input by a user or may be an automated process. The variable set identification 306 identifies a first set of variables 308 and a second set of variables 310. The subgroups of variables are then simulated at 312, where a first simulation method is applied to the first set of variables 308 and a second simulation method is applied to the second set of variables 310 while correlations among variables in both of the groups are maintained across the two different simulation methods. This process may be expanded to handle more than two subgroups where each additional subgroup of risk factors is simulated using a simulation method designated for that additional subgroup. For example, a third set of variables and a fourth set of variables may be identified by a variable set identification 306, and the third set of variables and the fourth set of variables may be simulated using a third simulation and a fourth simulation method, respectively. The simulated values for the input risk factors are output from the hybrid simulation engine 304 as a simulated forecast 314.

For example, historical time-series data for a set of risk factors, V1, V2, V3 and V4, may be received at 302. An automated variable set identification at 306 may determine that risk factors V1 and V3 have a high degree of information contribution, while risk factors V2 and V4 have a lesser degree of information contribution. Based on that determination, risk factors V1 and V3 may be identified as the first set of variables (“the priority set of variables”) while risk factors V2 and V4 are identified as the second set of variables (“the non-priority set of variables”). Because the priority set of variables has a high degree of information contribution, it may be desired to use a more expensive simulation method, such as a Monte Carlo simulation, to simulate those variables. While the non-priority set of variables may contribute less information, it may still be desirable to simulate those variables to maintain dependencies and correlations between non-priority set members and priority set members. Thus, the non-priority set of variables may be simulated using a less computation intensive simulation method such as a covariate simulation. The simulated outputs from the two different simulation techniques may then be output as a simulated forecast at 314.

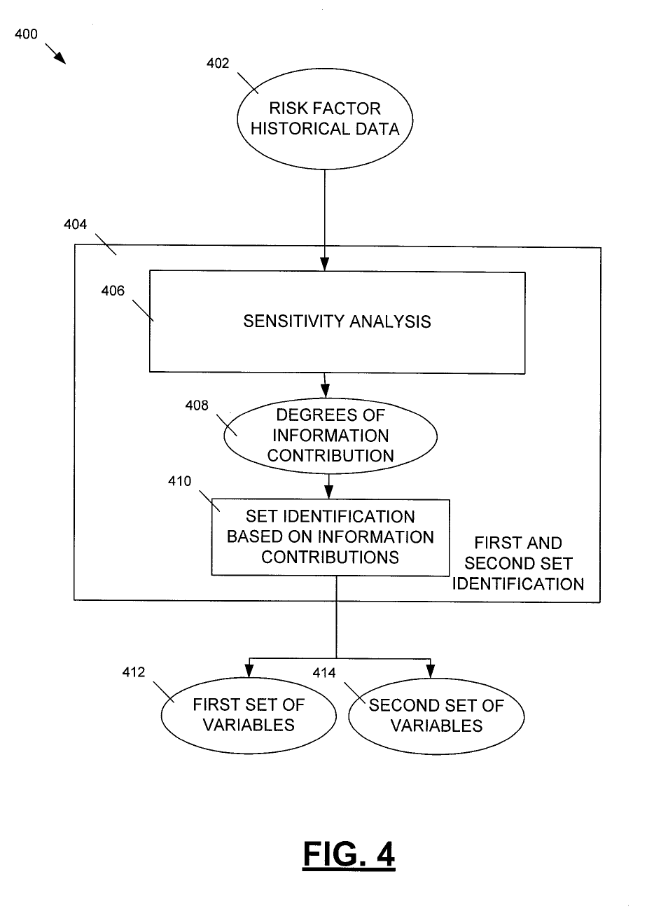

FIG. 4 is a flow diagram depicting an automated identification of risk factor subgroups. Risk factor historical data 402 is received for first and second set identification 404. A sensitivity analysis 406 is performed on the risk factor historical data 402 to identify an amount of information contribution 408 present in each risk factor variable. A set identification 410 is then performed based on the identified degrees of information contribution of the risk factor variables to identify a first set of variables 412 and second set of variables 414, as well as additional sets of variables where more than two subgroups are to be simulated. For example, risk factor variables having a high degree of information contribution may be identified as being members of a “priority” first set of variables 412, while risk factor variables having a low degree of information contribution may be identified as being members of a “non-priority” second set of variables 414.

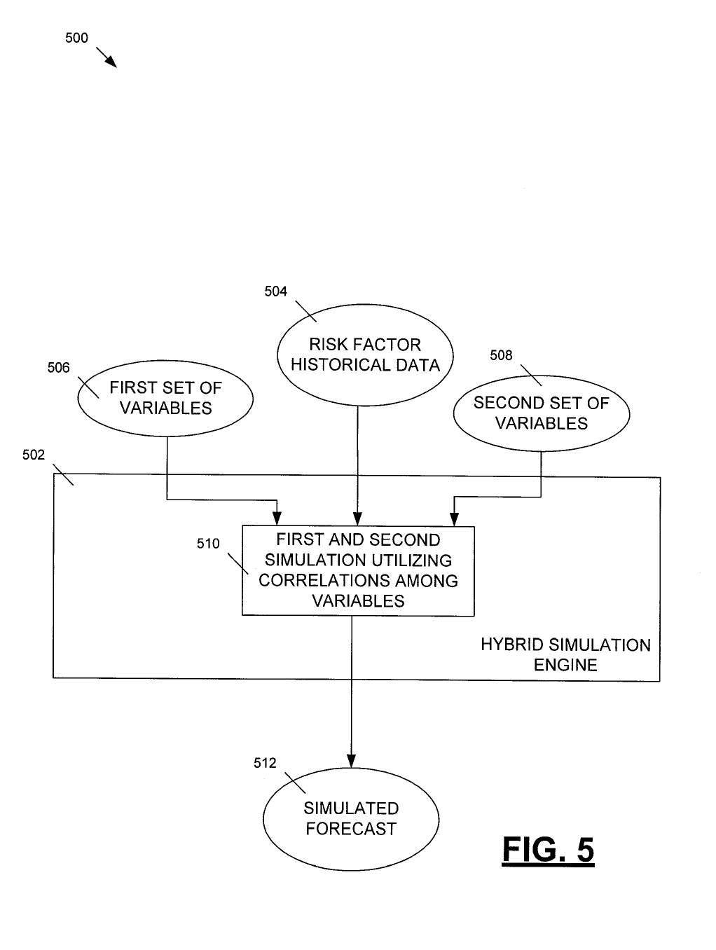

FIG. 5 is a flow diagram depicting a hybrid simulation process where the variable set identification is a manual process dictated by user or other external process input. The hybrid simulation engine 502 receives risk factor historical data 504 as well as definitions of which risk factors are in the first set of variables 506 and which are in the second set of variables 508. Upon receiving these inputs the hybrid simulation engine 502 performs first and second simulations 510 on the first set of variables 506 and the second set of variables 508, respectively, where the simulations are of different types may maintain correlations among the variables in the different sets of variables. The multiple simulations may differ in type by one or more of: the data model used, the number of historical time periods considered for a risk factor variable, complexity of the mathematical model, the amount of specification required, the source of input data, data differences required by regulatory, internal, or other policies, as well as other differences. The forecast values from the simulations performed at 510 for the one or more of the risk factor variables are output as a simulated forecast 512.

As an example, in a large risk management system, there may be different expectations of historical data for simulation analyses. For example, in Basel II (2004), banks are required to use at least five years of data to estimate the probability of defaults from external, internal, or pooled data sources. For loss given default and exposure at default, the minimum data observation period should be seven years. However, if the available observation period for one of these data sources spans a longer period for any other sources and that data is relevant and material, the longer period must be used according to the requirement of Basel II. Such a requirement results in a different length of historical data for different groups of risk factors within the single risk management system. The hybrid simulation engine 502 may handle such a scenario by receiving variable set data dividing the risk factors into subgroups according to the length of available historical data. A proper simulation method is applied to each subgroup of risk factors based on the length of available historical data to be used, and simulated forecast values for the risk factors may be output while maintaining correlations among the risk factors in different subgroups.

Maintaining correlations among risk factors in different subgroups may be important for generating accurate forecasts in some scenarios. For a large risk management system, different risk factors, due to their source and modeling expectations may require different simulation models and may not be implemented in one single simulation. Some risk factors may require model based simulation; the others may require empirical historical simulation. A hybrid simulation combines different simulation methods in one single simulation run in order to generate an aggregated scenario of the world. When risk factors are modeled marginally within each subgroup, a correlation structure is oftentimes desired on top of the groups in order to capture of the dependency among different risk factors.

For example, for a collateralized debt obligation (CDO), it is important to understand the correlated dependency among the underlying entities in the CDO pool in addition to the risk characteristics of the each individual entity. One lesson learned through recent financial crises is that a risk management system should not segregate the risk factors because the dependency greatly affects the outcome of simulated results. Using CDOs as an example, the senior tranche (the safest portion of a CDO) benefits from a low correlation of the underlying entities in the pool, while the equity tranche (the least protected portion of a CDO) benefits from a high correlation. The correlation of the housing market to these tranches has often been significantly understated by analysts. Considering this correlation, the safest portion of the CDOs (e.g. a AAA rated senior tranche of mortgage backed security) actually suffers much bigger losses than expected without maintenance of the correlation. Ignoring the correlation has caused many financial institutions which either hold such “safe” investments or provide protection to some of the CDO tranches to fail.

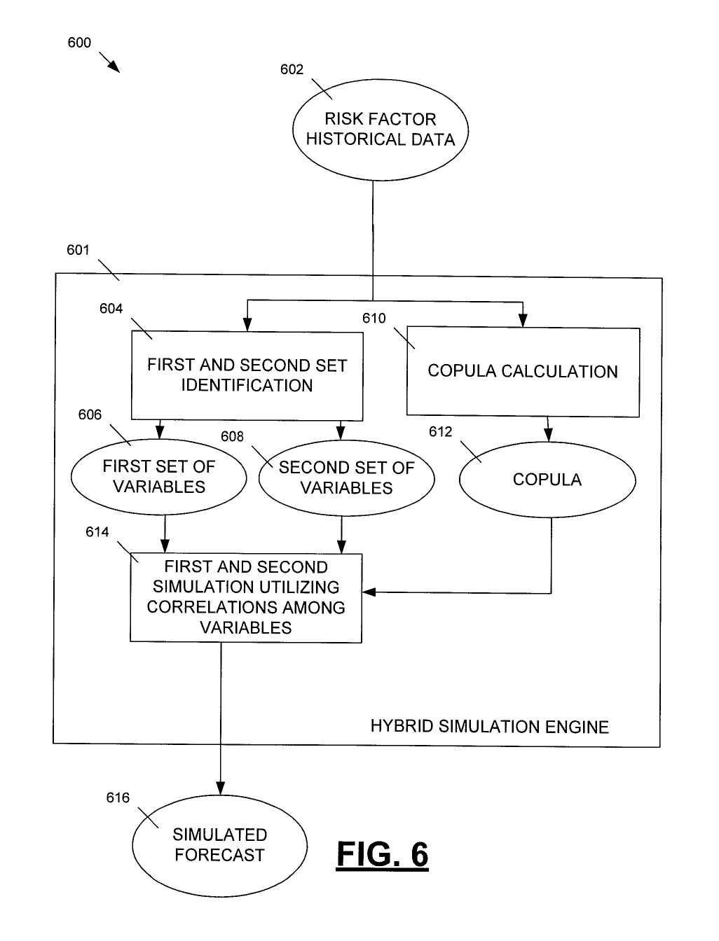

FIG. 6 is a flow diagram depicting a hybrid simulation engine that maintains correlations among risk factors in different subgroups using a copula. A hybrid simulation engine 601 receives risk factor historical data 602. A first and second set identification is performed at 604 to identify a plurality of subgroups of variables, such as a first set of variables 606 and a second set of variables 608. Additionally, the risk factor historical data 602 is utilized to perform a copula calculation 610 to generate a copula data structure 612 that is used to maintain correlations among the risk factor variables.

A copula is a mathematical framework that enables the separation of the correlation of a system of variables based on a marginal distribution of the variables. A copula may be a multivariate distribution having uniformly distributed values over (0,1) inclusively. For an n-dimensional random vector U on the unit cube, a copula C is:

C(u₁,u₂, . . . ,uₙ)=Pr(U₁≦u₁,U₂≦u₂, . . . ,Uₙ≦uₙ),

where Pr is a probability. A normal copula may be defined according to:

C_{Σ,F}_{₁}_{,F}_{₂}_{, . . . ,F}_{_{N}}(u₁,u₂, . . . ,u_{N})=Φ_{Σ}(F₁⁻¹(u₁),F₂⁻¹(u₂), . . . ,F_{N}⁻¹(u_{N})),
where Fₙ is the marginal distribution for risk factor input variable n;
where Σ is a matrix representing the received correlation data indicative of correlations among the members of the pool of risk factor input variables;
where Φ_{Σ} is a standardized multivariate normal distribution with correlation matrix Σ; and
where uₙ is uniform data for risk factor input variable n.
   Additional details of the properties of a Copula are described in Nelson, “An Introduction to Copulas,” Springer, 2006, the entirety of which is herein incorporated by reference. First and second simulations are performed on the first set of variables 606 and the second set of variables 608, respectively, using the copula 612 to maintain correlations among the risk factor variables at 614. The simulated forecast values 616 are then output from the hybrid simulation engine 601.

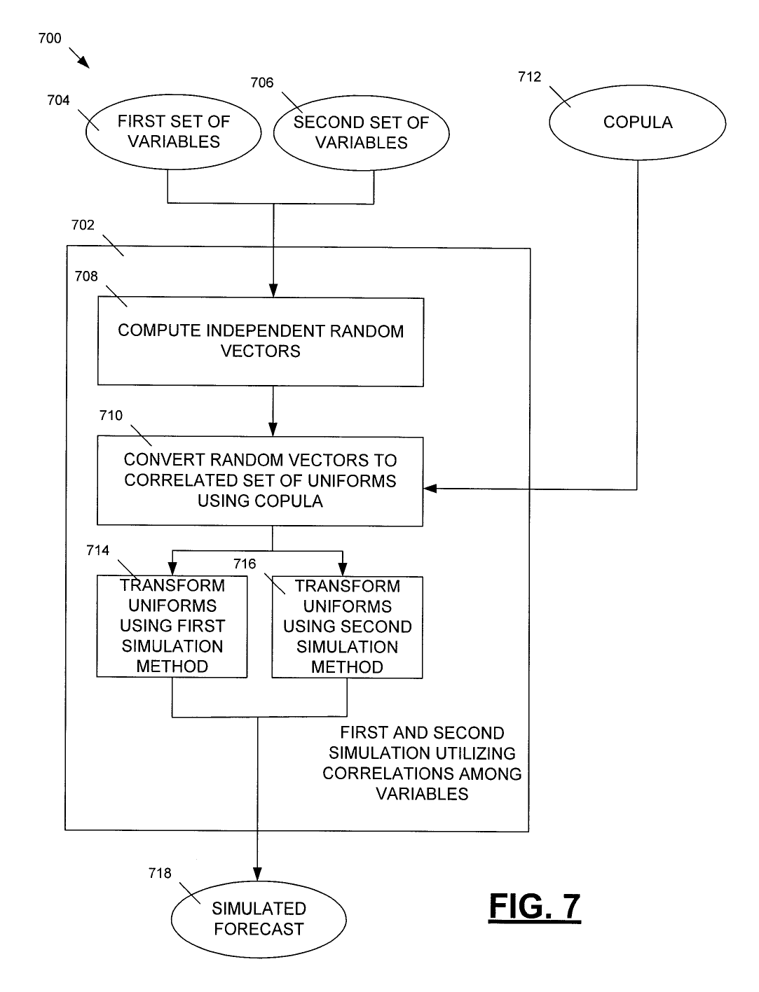

FIG. 7 is a flow diagram depicting a generation of a simulated forecast using a hybrid simulation engine that utilizes a copula to maintain correlations among variables. The first and second simulation 702 receives a first set of variables 704 and a second set of variables 706. The first and second simulations 702 compute independent random vectors at 708. For example, for an iteration of a Monte Carlo simulation of a subgroup of risk factor variables, a random number for each risk factor variable in a subgroup is generated and inserted into a random vector for the associated simulation. At 710, the random vectors are converted to a correlated set of uniforms using a received copula 712. Correlated uniforms may be calculated by:
calculating a Cholesky decomposition of Σ, as A;
where Σ identifies correlations among risk factor variables;
simulating n independent random variates z=(z₁, z₂, zₙ) from N(0,1)
defining x as Az; and
calculating uᵢ=Φ(xᵢ) for I=1, 2, . . . , n, where Φ is a univariate standard normal distribution function.

The uniforms are then transformed to marginal distributions based on the different simulation methods, as shown at 714, 716 where uniforms are transformed using the first simulation method at 714 and uniforms are transformed using a second simulation method at 716. Generating a first simulation and generating a second simulation may include generating a conditional normal distribution for a dependent set of risk factors variables in the first set of variables using a Schur complement based on correlations among members of the pool of input risk factor variables. The simulated forecasts 718 are then output from the simulated forecast.

An example hybrid simulation utilizing a conditional normal approach and the same example utilizing a copula approach are provided below. The example scenario contains two subgroups of risk factors. The first set of risk factor variables contains variables that that are modeled using the log return of equity prices that follow a random walk. That is, normally distributed draws are made that represent changes in the return process:

return_{i,t}=return_{i,t-1}+ε_{i,t}, where

ε_{i,t}=σᵣₑₜᵤᵣₙ_{ᵢ}*e_{i,t}, where

e_{i,t}˜Normal(0,1).

The second set of variables contains only one risk factor, a spot interest rate, which is modeled as a CIR (Cos-Ingersoll-Ross) model. The formula for this model is:

rateₜ=rateₜ₋₁+κ*(θ−rateₜ₋₁)+δₜ, where

δₜ=σᵣₐₜₑ*\sqrt{rateₜ₋₁}*ξₜ, where

ξₜ˜Normal(0,1).

In addition to the two models provided above, the two risk factors are related through the two error terms, as represented by the covariance matrix, Σ:

$$Σ = [ \begin{matrix}1 & 0.5 & - 0.2 \\ 0.5 & 1 & - 0.1 \\ - 0.2 & - 0.1 & 1\end{matrix} ] .$$

Converting independent random vectors to a correlated set of uniforms may utilize a Cholesky factorization of the covariance matrix. A Cholesky factorization is defined as:

Σ=LL^{T},

where L is a lower triangular matrix. For the sample covariance matrix above:

$$L = [ \begin{matrix}1 & 0 & 0 \\ 0.5 & 0.866 & 0 \\ - 0.2 & 0 & - 0.980\end{matrix} ] .$$

A multivariate normal distribution may then be simulated using the following steps:

(M1) Draw samples independently from normal(0,1). In the example scenario, three values are drawn in each scenario replication:

$$R = [ \begin{matrix}{r}_{1} \\ {r}_{2} \\ {r}_{3}\end{matrix} ] .$$

(M2) Transform the independent random draws to a correlated draw using the Cholesky factor:

Z=L^{T}*R.

(M3) Apply Z for the error terms in the model.
The target variable in this case could be the price of a basket option of the two equities. The price of this basket option is a function of the two return processes and the rate process:

pₜ=f(return_{1,t},return_{2,t},rateₜ).

The hybrid simulation may be performed via multiple different approaches. For example, using a conditional normal distribution using standard statistical result, the rate process may be identified by a priority risk factor and may be simulated using a Monte Carlo simulation, while the return processes may be identified as non-priority risk factors simulated using a covariance simulation. Conditional on the realization of the rate process, the error terms of the covariance simulations may be a simulation from a conditional normal (for each ξₜ=X) with the conditional mean and conditional variance for the return process error terms according to:

$${μ}_{ε \vert {ξ}_{t} = x} = [ \begin{matrix}- 0.2 \\ - 0.1\end{matrix} ] * x$$

$${Σ}_{{ξ}_{t} = x} = [ \begin{matrix}1 & 0.5 \\ 0.5 & 1\end{matrix} ] - [ \begin{matrix}- 0.2 \\ - 0.1\end{matrix} ] [ - 0.2 - 0.1 ] = [ \begin{matrix}0.96 & 0.48 \\ 0.48 & 0.99\end{matrix} ] ,$$

followed by an application of (M1)-(M3) in the conditional bi-variate normal distribution defined above. The three risk factors are simulated within the same system to generate the forecasted distribution for the target variables.

As another example, using a copula approach, the distribution of each risk factor variable may be computed. These distributions may have a functional form. However, simulated distribution or empirical distribution calculation may also be performed. A simulation may then be performed from a multivariate distribution according to (M1)-(M3). Using the marginal distribution of each process, the simulated values from the multivariate normal may be converted to form a vector of random values ranging from 0 to 1. Using the inverse cumulative distribution function that corresponds to each marginal distribution computed, the converted simulated value may be transformed to generate a simulated value for each risk factor variable.

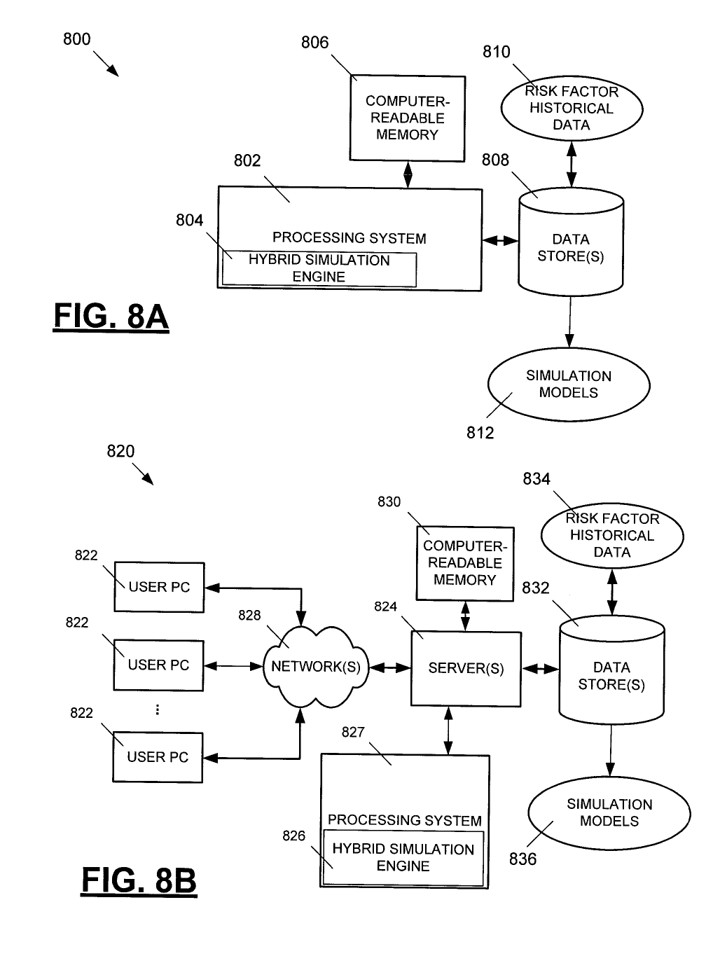

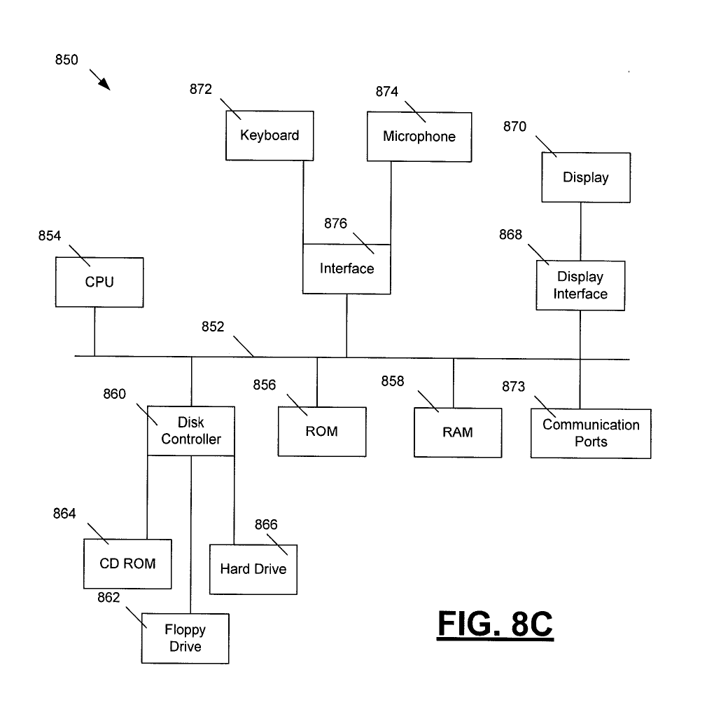

FIGS. 8A, 8B, and 8C depict example systems for use in implementing a hybrid simulation engine 804. For example, FIG. 8A depicts an exemplary system 800 that includes a stand alone computer architecture where a processing system 802 (e.g., one or more computer processors) includes a hybrid simulation engine 804 being executed on it. The processing system 802 has access to a computer-readable memory 806 in addition to one or more data stores 808. The one or more data stores 808 may contain risk factor historical data 810 as well as simulation models 812.

FIG. 8B depicts a system 820 that includes a client server architecture. One or more user PCs 822 accesses one or more servers 824 running a hybrid simulation engine 826 on a processing system 827 via one or more networks 828. The one or more servers 824 may access a computer readable memory 830 as well as one or more data stores 832. The one or more data stores 832 may contain risk factor historical data 834 as well as simulation models 836.

FIG. 8C shows a block diagram of exemplary hardware for a stand alone computer architecture 850, such as the architecture depicted in FIG. 8A, that may be used to contain and/or implement the program instructions of system embodiments of the present invention. A bus 852 may serve as the information highway interconnecting the other illustrated components of the hardware. A processing system 854 labeled CPU (central processing unit) (e.g., one or more computer processors), may perform calculations and logic operations required to execute a program. A processor-readable storage medium, such as read only memory (ROM) 856 and random access memory (RAM) 858, may be in communication with the processing system 854 and may contain one or more programming instructions for performing the method of implementing a hybrid simulation engine. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 856 to be displayed on a display 870 in audio, graphic, or alphanumeric format. Communication with external devices may optionally occur using various communication ports 873.

In addition to the standard computer-type components, the hardware may also include data input devices, such as a keyboard 872, or other input device 874, such as a microphone, remote control, pointer, mouse and/or joystick.

This written description uses examples to disclose the invention, including the best mode, and also to enable a person skilled in the art to make and use the invention. The patentable scope of the invention may include other examples. For example, in addition to simulating risk factor variables, many other different types of variables may be simulated using a hybrid simulation engine. As a further example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for providing a simulated forecast based on correlated members of a pool of input risk factor variables representing input data, the method comprising:
identifying certain members of the pool of input risk factor variables as being members of a first set of variables, and identifying certain other members of the pool of input risk factor variables as being members of a second set of variables;
generating a first simulation via a first simulation method using the first set of variables to generate a set of first results;
generating a second simulation via a second simulation method that differs from the first simulation method using the second set of variables to generate a set of second results;
the first simulation and the second simulation being generated utilizing correlations among variables in the first set of variables and variables in the second set of variables; and
storing the set of first results and the set of second results as a simulated forecast in a computer-readable memory.

2. The method of claim 1, wherein the first simulation method and the second simulation methods differ in that the first simulation method is more time and computational-resource intensive than the second simulation method.

3. The method of claim 1, wherein the first simulation method and the second simulation methods differ in that the first simulation method considers more historical data points of variables in first set of variables than the second simulation method considers of variables of the second set of variables.

4. The method of claim 3, wherein the first simulation is required by law to consider more historical data points of the variables of first set of variables than the second simulation method considers of the variables of second set of variables.

5. The method of claim 1, further comprising:
identifying certain other members of the pool of input risk factor variables as being members of a third set of variables;
generating a third simulation via a third simulation method that differs from the first simulation method and the second simulation method using the third set of variables to generate a set of third results; and
storing the set of third results with the set of first results and the set of second results as the simulated forecast.

6. The method of claim 1, further comprising:
generating a copula indicative of correlation among variables in the first set of variables and variables in the second set of variables using the input data;
utilizing the copula in the first simulation and the second simulation to incorporate correlations among variables in the first set of variables and variables in the second set of variables.

7. The method of claim 6, further comprising:
computing independent random vectors for each variable in the first set of variables and each variable in the second set of variables;
converting the independent random variables into a set of correlated uniforms using the copula;
applying the first simulation and the second simulation to the set of correlated uniforms.

8. The method of claim 6, wherein the copula is a multivariate distribution having uniformly distributed values over (0,1) inclusively.

9. The method of claim 1, wherein the priority simulation method is a simulation method selected from the group consisting of: Monte-Carlo simulation, covariate simulation, historical simulation, and scenario simulation.

10. The method of claim 1, wherein the non-priority simulation method is a simulation method that differs from the priority simulation method selected from the group comprising: Monte-Carlo simulation, covariate simulation, historical simulation and scenario simulation.

11. The method of claim 1, wherein the members of the first set of variables are identified based on a sensitivity analysis of the members of the pool of input risk factor variables, where a degree of information contribution of each variable in the pool of input risk factor variables is calculated, and variables having a highest degree of information contribution are identified as members of the first set of variables.

12. The method of claim 1, further comprising calculating a target forecast value based on multiple simulated forecast values and storing the target forecast value in a computer-readable memory.

13. The method of claim 6, wherein generating a copula (C) based on the correlation data comprises calculating:
C_{Σ,F}_{₁}_{,F}_{₂}_{, . . . ,F}_{_{N}}(u₁,u₂, . . . ,u_{N})=Φ_{Σ}(F₁⁻¹(u₁),F₂⁻¹(u₂), . . . ,F_{N}⁻¹(u_{N})),
where Fₙ is the marginal distribution for risk factor input variable n;
where Σ is a matrix representing the received correlation data indicative of correlations among the members of the pool of risk factor input variables;
where Φ_{Σ} is a standardized multivariate normal distribution with correlation matrix Σ; and
uₙ is uniform data for risk factor input variable n.

14. The method of claim 6, wherein generating a first simulation and generating a second simulation includes generating a conditional normal distribution for a dependent set of risk factors variables in the first set of variables using a Schur complement based on correlations among members of the pool of input risk factor variables.

15. The method of claim 7, wherein the correlated uniforms are calculated by:
calculating a Cholesky decomposition of Σ, as A;
wherein Σ identifies correlations among risk factor variables;
simulating n independent random variates z=(z₁, z₂, . . . ,zₙ) from N(0,1)
defining x as Az; and
calculating uᵢ=Φ(xᵢ) for I=1, 2, . . . , n, where Φ is a univariate standard normal distribution function.

16. A computer-implemented system for providing a simulated forecast based on correlated members of a pool of input risk factor variables representing input data, the system comprising:
a data processor;
a computer-readable memory encoded with instructions for commanding the data processor to implement a method, the method comprising:
identifying certain members of the pool of input risk factor variables as being members of a first set of variables, and identifying certain other members of the pool of input risk factor variables as being members of a second set of variables;
generating a first simulation via a first simulation method using the first set of variables to generate a set of first results;
generating a second simulation via a second simulation method that differs from the first simulation method using the second set of variables to generate a set of second results;
the first simulation and the second simulation being generated utilizing correlations among variables in the first set of variables and variables in the second set of variables; and
storing the set of first results and the set of second results as a simulated forecast in a computer-readable memory.

17. The system of claim 16, wherein the first simulation method and the second simulation methods differ in that the first simulation method is more time and computational-resource intensive than the second simulation method.

18. The system of claim 16, wherein the method further comprises:
generating a copula indicative of correlation among variables in the first set of variables and variables in the second set of variables using the input data;
utilizing the copula in the first simulation and the second simulation to incorporate correlations among variables in the first set of variables and variables in the second set of variables.

19. The system of claim 16, wherein the method further comprises calculating a target forecast value based on multiple simulated forecast values and storing the target forecast value in a computer-readable memory.

20. A computer-readable memory encoded with instructions for commanding a data processor to execute a method, the method comprising:
identifying certain members of the pool of input risk factor variables as being members of a first set of variables, and identifying certain other members of the pool of input risk factor variables as being members of a second set of variables;
generating a first simulation via a first simulation method using the first set of variables to generate a set of first results;
generating a second simulation via a second simulation method that differs from the first simulation method using the second set of variables to generate a set of second results;
the first simulation and the second simulation being generated utilizing correlations among variables in the first set of variables and variables in the second set of variables; and
storing the set of first results and the set of second results as a simulated forecast in a computer-readable memory.
